(19) United States
(12) Patent Application Publication
(10) Pub. No.: US 2026/0307470 A1
(43) Pub. Date: Oct. 8, 2026

(54) VEHICLE LOWER STRUCTURE

(71) Applicant: MAZDA MOTOR CORPORATION, Hiroshima (JP)

(72) Inventors: Yoshikazu NISHIMURA, Hiroshima (JP); Hiromasa HONJI, Hiroshima (JP); Taiki YOTSUYANAGI, Hiroshima (JP)

(73) Assignee: MAZDA MOTOR CORPORATION, Hiroshima (JP)

(21) Appl. No.: 19/557,609

(22) Filed: Mar. 5, 2026

(30) Foreign Application Priority Data
Apr. 4, 2025 (JP) 2025-062289

(51) Int. Cl. B60K 1/04; B62D 21/15; B62D 25/02

(52) U.S. Cl. CPC B60K 1/04; B62D 21/157; B62D 25/025; B60K 2001/0438

(57) ABSTRACT

To increase mounting capacity of a battery while ensuring an energy absorptive function during a side collision, a vehicle lower structure includes a side sill that has a closed cross-section located in a side end portion of a floor panel in a vehicle width direction and extending in a vehicle front-rear direction; a battery casing that is located under the floor panel and has a battery accommodated in an accommodation space; and a fastening portion that fastens the battery casing to a lower portion of the side sill. The fastening portion is located at a position that overlaps a cross-sectional center of the side sill in the vehicle width direction, or is located on an outer side of the cross-sectional center in the vehicle width direction.

### TECHNICAL FIELD

The present disclosure relates to a vehicle lower structure.

### BACKGROUND

A conventional vehicle body lower structure is described in JP2018-188086A. The vehicle body lower structure includes a battery pack, which accommodates a battery, under a floor panel. A battery pack frame is attached to a side wall of the battery pack. The battery pack frame includes a fixing portion and a frame body. The fixing portion is fastened to an inner side sill in a lower portion of a side sill that includes the inner side sill and an outer side sill. On an inner side of the side sill in a vehicle width direction, the frame body rises along an inner wall of the side sill and is joined to the side wall of the battery pack.

In the conventional vehicle body lower structure, the side sill and the battery pack frame are arranged side-by-side in the vehicle width direction. Since the battery pack is located on the inner side of the battery pack frame in the vehicle width direction, a length in the vehicle width direction of the battery pack between the battery pack frames, which are arranged on right and left sides in the vehicle width direction, is reduced. The conventional vehicle body lower structure limits capacity of the battery pack that can be mounted on a vehicle.

In the conventional vehicle body lower structure, for example, it is considered advantageous to reduce a width of the battery pack frame in the vehicle width direction. When the width of the battery pack frame is reduced, the battery pack can be expanded outward in the vehicle width direction by the reduced width.

Together with the side sill, the battery pack frame has a function to absorb energy during a side collision. When the width of the battery pack frame is reduced, an absorbable amount of energy is reduced. From a viewpoint of avoiding input of a collision load to the battery pack, it is difficult to reduce the width of the battery pack frame.

### SUMMARY

The present disclosure increases a mounting capacity of a battery while ensuring an energy absorptive function during a side collision.

The present disclosure relates to a vehicle lower structure. This vehicle lower structure includes:
a side sill that has a closed cross-section located in a side end portion of a floor panel in a vehicle width direction and extending in a vehicle front-rear direction;
a battery casing that is located under the floor panel and has a battery accommodated in an accommodation space; and
a fastening portion that fastens the battery casing to a lower portion of the side sill.

The fastening portion is located at a position that overlaps a cross-sectional center of the side sill in the vehicle width direction, or is located on an outer side of the cross-sectional center in the vehicle width direction.

In this vehicle lower structure, the fastening portion is located at the position that overlaps the cross-sectional center of the side sill in the vehicle width direction, or is located on the outer side of the cross-sectional center in the vehicle width direction, and fastens the side sill and the battery casing. The cross-sectional center may be a geometric center of a cross section of the side sill.

A part of the battery casing is at least located on the outer side of the fastening portion in the vehicle width direction. In the vehicle width direction, since the fastening portion is located near the outer side in the vehicle width direction of the side sill, the outer end of the battery casing in the vehicle width direction is located at the position on the outer side of the fastening portion and near the outer end of the side sill in the vehicle width direction.

When an initial collision load is input to the side sill during a side collision, the initial collision load is also input to the battery casing at the same timing or at substantially the same timing.

After the initial collision load is input, the side sill and the battery casing absorb energy in parallel.

As a result, the vehicle lower structure can reduce an energy absorption stroke with respect to the load input during the side collision.

Since the energy absorption stroke by the side sill and the battery casing is short, the accommodation space of the battery can be expanded in the vehicle width direction. Due to the expansion of the accommodation space, it is possible to increase mounting capacity of the battery.

Therefore, the vehicle lower structure can increase the mounting capacity of the battery while ensuring an energy absorptive function during the side collision.

The battery casing may have a frame that is located in an outer edge portion of the battery casing in the vehicle width direction, extends in the vehicle front-rear direction, and forms the accommodation space on an inner side in the vehicle width direction, and
the fastening portion may fasten the frame to the lower portion of the side sill.

During the side collision, the collision load is input to both the side sill and the frame. In the case where the frame has the energy absorptive function, the vehicle lower structure can further reduce the energy absorption stroke during the side collision. This structure is advantageous for an increase in the mounting capacity of the battery.

An inner end of the side sill in the vehicle width direction may be located at the same position as an inner end of the frame in the vehicle width direction, or may be located on an outer side of the inner end of the frame in the vehicle width direction.

The fact that the inner end of the side sill in the vehicle width direction is located at the same position as the inner end of the frame in the vehicle width direction means that the frame is not located on the inner side of the side sill in the vehicle width direction. That is, since the frame is located on the outer side in the vehicle width direction, the accommodation space of the battery can be expanded in the vehicle width direction.

In addition, when the inner end of the side sill in the vehicle width direction is located on the outer side of the inner end of the frame in the vehicle width direction, this is advantageous for improvement in getting-on/off performance of the vehicle since the side sill has a narrow width in the vehicle width direction.

In the vehicle width direction, an outer end of the frame in the vehicle width direction may be located at substantially the same position as an outer end of the side sill in the vehicle width direction.

In the case where the outer end of the frame and the outer end of the side sill are located at substantially the same position, both the side sill and the frame can receive the initial collision load during the side collision. Both the side sill and the frame receive the load from an early stage of the collision, and this is advantageous for a reduction in the energy absorption stroke.

The vehicle lower structure may further include a jack-up attachment that is attached to a lower surface of the frame.

The vehicle may receive a jack-up load via the frame.

The jack-up attachment may have a fixing portion that penetrates the frame in an up-down direction and is fixed to a lower portion of the side sill.

The jack-up load is input to the side sill via the fixing portion of the jack-up attachment. The frame and the side sill can secure required rigidity for the jack-up load.

The frame may be an extruded material of an aluminum alloy.

The extruded material of the aluminum alloy is suitable for use in the battery casing in terms of light weight, corrosion resistance, and heat dissipation.

Although the extruded material of the aluminum alloy has relatively low rigidity, the required rigidity against the jack-up load can be secured by both the side sill and the frame.

The side sill may have an inner and an outer that are joined to each other in the vehicle width direction, and
the fastening portion may be fastened to the outer.

The outer is an outer portion that is located on the relatively outer side in the vehicle width direction in the side sill. Since the fastening portion is fastened to the outer, the outer end of the frame in the vehicle width direction is located at a position near the outer end of the side sill in the vehicle width direction. The side sill and the frame can receive the initial collision load and can absorb the energy in parallel. It is possible to further reduce the energy absorption stroke with respect to the input load.

The fastening portion may include a collar that is interposed between a lower portion of the side sill and the frame; and a bolt that is inserted in the collar and fastens the frame and the side sill.

The collar of the fastening portion may be located at a position that overlaps a cross-sectional center of the side sill, or the collar of the fastening portion may be located on the outer side of the cross-sectional center in the vehicle width direction.

The vehicle lower structure can increase the mounting capacity of the battery while ensuring the energy absorptive function during the side collision.

### BRIEF DESCRIPTION OF THE DRAWINGS

FIG. 1 illustrates a vehicle to which a lower structure disclosed herein is applied.

FIG. 2 is a cross-sectional view taken along line II-II in FIG. 1.

FIG. 3 is a cross-sectional view taken along line III-III in FIG. 1.

FIG. 4 includes views for comparing a stroke amount with respect to a collision load between the conventional lower structure and the lower structure disclosed herein.

FIG. 5 illustrates a modified example of the disclosed lower structure.

FIG. 6 illustrates another modified example of the disclosed lower structure.

### DETAILED DESCRIPTION

A description will hereinafter be made on an embodiment of a vehicle lower structure with reference to the drawings. The vehicle lower structure described herein is illustrative. The vehicle lower structure relates to a vehicle in which a battery is mounted under a floor.

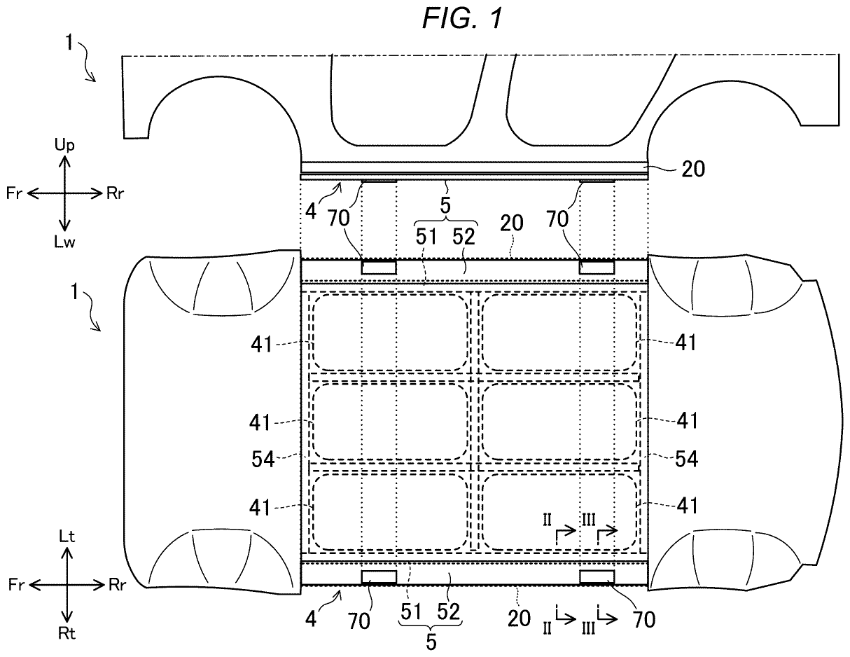

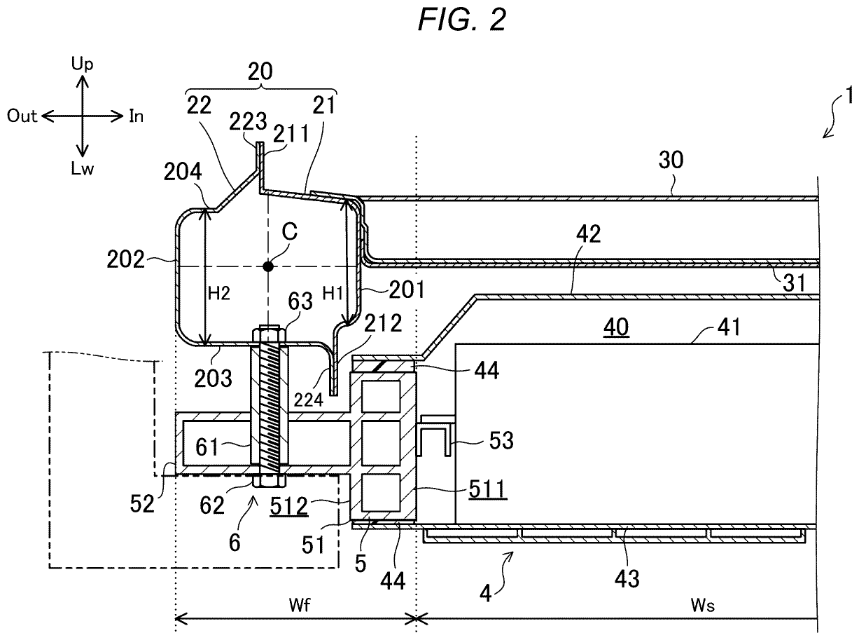

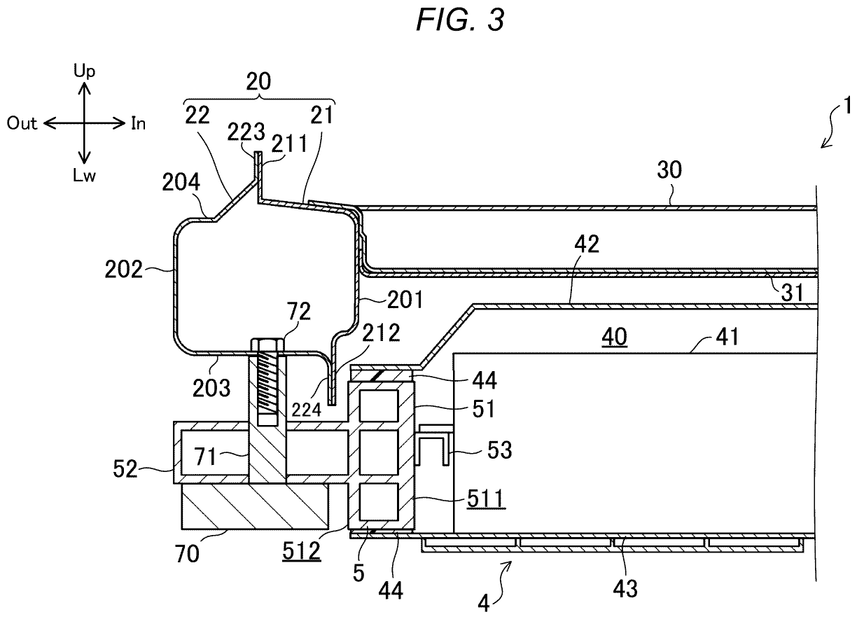

FIG. 1 illustrates a vehicle 1 to which the lower structure disclosed herein is applied. An upper view in FIG. 1 is a side view in which a lower portion of the vehicle 1 is viewed from the left, and a lower view therein is a bottom view in which a portion under a floor of the vehicle 1 is viewed from below. FIG. 2 is a cross-sectional view taken along line II-II in FIG. 1, and FIG. 3 is a cross-sectional view taken along line III-III in FIG. 1.

In each of the drawings, Fr indicates a front side of the vehicle 1, and Rr indicates a rear side of the vehicle 1. Rt indicates a right side of the vehicle 1, and Lt indicates a left side of the vehicle 1. A right-left direction of the vehicle 1 corresponds to a vehicle width direction, In indicates an inner side in the vehicle width direction, and Out indicates an outer side in the vehicle width direction. Up indicates an upper side of the vehicle 1, and Lw indicates a lower side of the vehicle 1.

The lower structure of the vehicle 1 includes a side sill 20. The side sill 20 is located in each of a right portion and a left portion of a floor panel 30 in the vehicle width direction. The floor panel 30 expands in a vehicle front-rear direction and the vehicle width direction to form a cabin floor.

In each of the right portion and the left portion of the floor panel 30, the side sill 20 continuously extends in the vehicle front-rear direction.

As illustrated in FIG. 2 or 3, the side sill 20 includes an inner 21 and an outer 22. The inner 21 and the outer 22 are arranged side-by-side in the vehicle width direction and joined to each other. The side sill 20 has a closed cross-section that is formed by the inner 21 and the outer 22.

More specifically, the inner 21 has a first flange 211 and a second flange 212 and has a lateral hat shape as a whole. The outer 22 has a third flange 223 and a fourth flange 224 and has a lateral hat shape as a whole. The inner 21 and the outer 22 are each made of a steel plate that is processed into the hat shape.

In an upper portion of the side sill 20, the first flange 211 and the third flange 223 oppose each other in the vehicle width direction and are joined to each other. In a lower portion of the side sill 20, the second flange 212 and the fourth flange 224 oppose each other in the vehicle width direction and are joined to each other. A joint position between the second flange 212 and the fourth flange 224 is shifted inward in the vehicle width direction from a joint position between the first flange 211 and the third flange 223. The joint position between the second flange 212 and the fourth flange 224 is located near an inner wall 201 of the side sill 20 in the vehicle width direction. The inner wall 201 is a side wall of the side sill 20 that is formed by the inner 21, and is a side wall that is located on the inner side in the vehicle width direction in the side sill 20.

An outer wall 202 of the side sill 20 is formed by the outer 22, and a lower wall 203 of the side sill 20 is also substantially formed by the outer 22. The outer wall 202 is a side wall that is located on the outer side in the vehicle width direction in the side sill 20. The lower wall 203 is a wall that constitutes the lower portion of the side sill 20. An upper wall 204 of the side sill 20 is formed by the inner 21 and the outer 22. The upper wall 204 is a wall that constitutes the upper portion of the side sill 20. A side end portion of the floor panel 30 in the vehicle width direction is joined to the inner 21 in the upper wall 204.

A height H2 of the outer 22 is higher than a height H1 of the inner 21. The side sill 20 can secure high rigidity.

A reference sign 31 indicates a cross member 31. The cross member 31 extends in the vehicle width direction along a lower surface of the floor panel 30. An end portion of the cross member 31 in the vehicle width direction is joined to the inner wall 201 of the side sill 20.

The lower structure of the vehicle 1 includes a battery casing 4. The battery casing 4 is located under the floor panel 30.

The battery casing 4 includes a battery 41 that is accommodated in an accommodation space 40. The battery 41 described herein is a battery module that includes plural battery cells. As illustrated in FIG. 1, the battery casing 4 includes the plural batteries 41. The plural battery casings 4 are aligned in the vehicle front-rear direction and the vehicle width direction.

The number of the batteries 41 that are accommodated in the accommodation space 40 is not limited to a specific number. In addition, the battery module may be omitted, and the battery cells may directly be accommodated in the accommodation space 40.

The battery casing 4 includes a frame 5. The frame 5 is located in each of a right edge portion and a left edge portion that are outer edge portions of the battery casing 4 in the vehicle width direction. The frame 5 continuously extends in the vehicle front-rear direction from a front end to a rear end of the side sill 20. The frame 5 forms the accommodation space 40 on the inner side in the vehicle width direction.

The frame 5 has a transverse T-shaped cross section. The frame 5 has a body portion 51. The body portion 51 has an inner surface 511 that expands in an up-down direction and extends in the vehicle front-rear direction. The inner surface 511 forms the accommodation space 40. A height of the body portion 51 is substantially the same as a height of the battery 41 that is accommodated in the accommodation space 40.

A cover 42 is joined to an upper portion of the body portion 51. The cover 42 expands in the vehicle front-rear direction and the vehicle width direction and forms an upper portion of the accommodation space 40. In order to be arranged closer to the floor panel 30, a central portion of the cover 42 is located higher than a peripheral portion including an outer peripheral edge portion of the cover 42, that is, the outer peripheral edge portion that is joined to the upper portion of the body portion 51. This is advantageous for an increase in mounting capacity of the battery 41 since the accommodation space 40 is expanded in the up-down direction.

A base 43 is joined to a lower portion of the body portion 51. The base 43 expands in the vehicle front-rear direction and the vehicle width direction and forms a lower portion of the accommodation space 40. The battery 41 is placed on the base 43. The battery 41 is supported by a bracket 53 that is fixed to the inner surface 511 of the body portion 51.

Seals 44 are interposed between the body portion 51 and the cover 42 and between the body portion 51 and the base 43, respectively. The accommodation space 40 is a sealed space.

The frame 5 has an extended portion 52. The extended portion 52 protrudes outward in the vehicle width direction from an outer surface 512 of the body portion 51. The extended portion 52 is located under the side sill 20.

A length of the extended portion 52 in the vehicle width direction is longer than a length of the body portion 51 in the vehicle width direction. The length of the extended portion 52 in the vehicle width direction is the same or substantially the same as a width of the side sill 20 in the vehicle width direction. The body portion 51 is largely located on the inner side of the side sill 20 in the vehicle width direction.

The extended portion 52 is located near a center of the body portion 51 in a height direction. A height of the extended portion 52 is lower than the height of the body portion 51. In the up-down direction, the extended portion 52 is located near lower ends of the second flange 212 and the fourth flange 224. In the up-down direction, the upper portion of the body portion 51 overlaps the second flange 212 and the fourth flange 224.

The extended portion 52 continuously extends in the vehicle front-rear direction from the front end to the rear end of the side sill 20.

The frame 5 is made of an extruded material of an aluminum alloy, for example. The body portion 51 and the extended portion 52 are integrally molded. The frame 5 has plural closed cross-sections therein. As will be described below, the frame 5 has rigidity against a collision load from a side surface, and can secure a required energy absorption amount. The illustrated cross-sectional shape of the frame 5 is merely an example.

As illustrated in FIG. 1, the battery casing 4 also includes a frame 54 that is located in each of a front edge portion and a rear edge portion of the battery casing 4 in the vehicle front-rear direction. The frames 54 each extend in the vehicle width direction from the right frame 5 to the left frame 5 and form the accommodation space 40.

The lower structure of the vehicle 1 includes a fastening portion 6. The fastening portion 6 fastens the battery casing 4 to the lower portion of the side sill 20. In detail, the fastening portion 6 fastens the extended portion 52 of the frame 5 to the lower wall 203 of the side sill 20. The fastening portion 6 fastens the frame 5 to the lower portion of the side sill 20 at plural positions that are spaced apart in the vehicle front-rear direction.

The fastening portion 6 has a collar 61. The collar 61 is joined to the lower wall 203 of the side sill 20 and extends downward from the lower wall 203. A lower end portion of the collar 61 is inserted in a hole, which is formed in the extended portion 52 of the frame 5, from above.

The fastening portion 6 has a bolt 62. The bolt 62 is inserted in the collar 61 from a lower surface of the extended portion 52 and penetrates the lower wall 203 of the side sill 20. When a nut 63 is screwed to the bolt 62, the extended portion 52 is supported by the lower wall 203 of the side sill 20, that is, the outer 22.

As illustrated in FIG. 3, the lower structure of the vehicle 1 includes a jack-up attachment 70. The jack-up attachment 70 constitutes a jack-up point at the time of jacking up the vehicle 1 (see also FIG. 1).

The jack-up attachment 70 is attached to the lower surface of the extended portion 52 of the frame 5. The jack-up attachment 70 has a fixing portion 71. The fixing portion 71 extends upward from an upper surface of the jack-up attachment 70 and penetrates the extended portion 52 in the up-down direction. An upper end of the fixing portion 71 is fixed to the lower wall 203 of the side sill 20 by a bolt 72.

As illustrated in FIG. 2, in this lower structure, the entire side sill 20 overlaps the frame 5 in the vehicle width direction (see Wf in FIG. 2). That is, the side sill 20 does not protrude outward from the frame 5 in the vehicle width direction. The side sill 20 and the frame 5 substantially overlap each other in the up-down direction.

Since the side sill 20 does not protrude outward from the frame 5 in the vehicle width direction, both the side sill 20 and the frame 5, which overlap each other in the up-down direction, receive an initial collision load during a side collision. In addition, since the side sill 20 and the frame 5 substantially overlap each other in the up-down direction, the side sill 20 and the frame 5 absorb the energy in parallel.

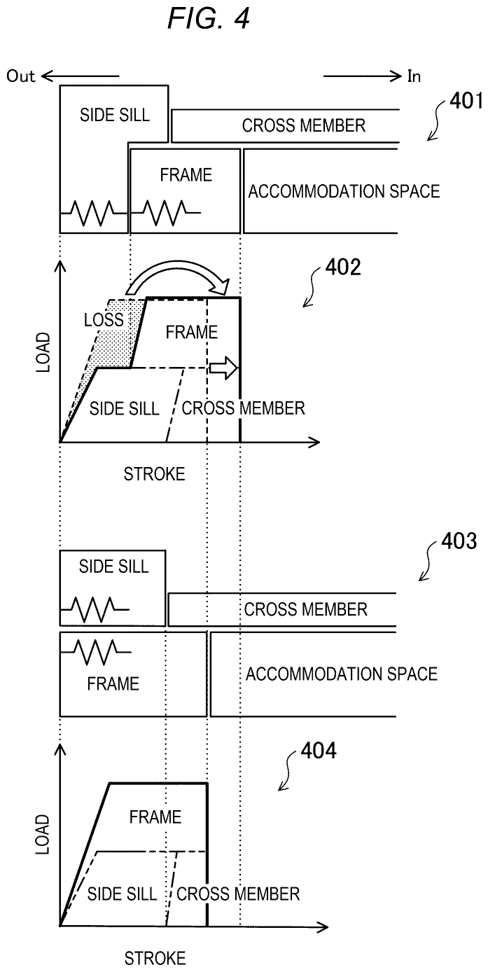

FIG. 4 includes views for comparing the conventional lower structure with the lower structure disclosed herein. An upper view 401 in FIG. 4 schematically illustrates the conventional lower structure, and a lower view 403 schematically illustrates the lower structure disclosed herein.

In the conventional lower structure, the side sill is located on the outer side of the frame of the battery casing in the vehicle width direction. The side sill and the frame are arranged side-by-side in the vehicle width direction. The battery accommodation space is formed on the inner side of the frame in the vehicle width direction.

When the side collision load is input to a vehicle having the conventional lower structure, as indicated by a graph 402 of load versus stroke, only the side sill receives the initial collision load. At this time, a stroke of the lower structure is defined only by the rigidity of the side sill. Thus, the stroke is relatively large with respect to the load.

Then, shortly after the side sill collapses and absorbs the energy of the collision load, the frame starts absorbing the energy of the collision load.

In the conventional lower structure, only the side sill receives the initial collision load, and the side sill and the frame absorb the energy in series. Compared to the lower structure (see broken lines in the graph 402) that is disclosed herein and described below, the conventional lower structure (see solid lines in the graph 402) causes energy absorption loss at an early stage of the collision. In the conventional lower structure, the stroke has to be extended to compensate for the energy absorption loss (see outline arrows in the graph 402). In the conventional lower structure, due to a reason of securing the long stroke, the battery accommodation space cannot be expanded outward in the vehicle width direction.

Meanwhile, in the lower structure disclosed herein, as described above, both the side sill 20 and the frame 5, which overlap each other in the up-down direction, receive the initial collision load. In addition, the side sill 20 and the frame 5 absorb the energy in parallel from the early stage of the collision. As indicated by a graph 404, there is no energy absorption loss at the early stage of the collision. Thus, compared to the conventional lower structure, the lower structure disclosed herein can reduce the energy absorption stroke with respect to the load input. As a result, in the lower structure disclosed herein, the accommodation space 40 for the battery 41 can be expanded outward in the vehicle width direction (see an arrow Ws in FIG. 2).

Due to the expansion of the accommodation space 40, it is possible to increase the mounting capacity of the battery 41 in the vehicle 1. In the lower structure of the vehicle 1 disclosed herein, it is possible to increase the mounting capacity of the battery 41 while ensuring an energy absorptive function during the side collision by the side sill 20 and the frame 5 that are aligned in the up-down direction.

As illustrated in FIG. 2, an outer end of the extended portion 52 of the frame 5 is located at substantially the same position as the outer wall 202 of the side sill 20 in the vehicle width direction. Accordingly, both the side sill 20 and the frame 5 can receive the initial collision load during the side collision. Both the side sill 20 and the frame 5 receive the load from the early stage of the collision, and this is advantageous for a reduction in the energy absorption stroke.

The positions of the outer end of the extended portion 52 and the outer wall 202 of the side sill 20 are not limited to being completely the same, and slight shifting therebetween is allowed. The outer end of the extended portion 52 may be located on the inner side or the outer side of the outer wall 202 of the side sill 20 in the vehicle width direction.

The height of the body portion 51 of the frame 5 is substantially the same as the height of the battery 41. Since the body portion 51 has a relatively large height, the body portion 51 can contribute to securing the high rigidity of the frame 5.

Meanwhile, the height of the extended portion 52 is lower than that of the body portion 51. Since the height of the extended portion 52, which is located under the side sill 20, is low, the battery casing 4 can be brought close to the side sill 20 and the floor panel 30. It is possible to expand the accommodation space 40 for the battery 41 in the up-down direction while suppressing an increase in a vehicle height.

When the collision load is input, the body portion 51, which has a relatively large height, supports the extended portion 52, which is located relatively low. This allows the entire frame 5 to have the high rigidity and is also advantageous to absorb the energy.

Since the extended portion 52 is located at a central portion of the outer surface 512 of the body portion 51 in the height direction, the frame 5 can exhibit stable deformation behavior during the side collision. The extended portion 52 may be located at an upper end portion or a lower end portion of the outer surface 512 of the body portion 51 in the height direction. The frame 5 may have an L-shaped cross section.

At the position under the side sill 20, the extended portion 52 continuously extends from a front end portion to a rear end portion of the side sill 20 in the vehicle front-rear direction. Regardless of the position at which the collision load is input on the side surface of the vehicle 1, together with the side sill 20, the extended portion 52 can receive the initial collision load.

Since the extended portion 52 continuously extends in the vehicle front-rear direction, the jack-up attachment 70 is attached to the lower surface of the extended portion 52. Since the jack-up attachment 70 has the fixing portion 71, a jack-up load is mainly input to the side sill 20 via the fixing portion 71. The frame 5 and the side sill 20 can secure the required rigidity for the jack-up load that is locally input to the vehicle 1.

The frame 5 is the extruded material of the aluminum alloy, and is suitable for the battery casing 4 in terms of light weight, corrosion resistance, and heat dissipation. Meanwhile, the frame 5, which is made of the extruded material of the aluminum alloy, has lower rigidity than the side sill 20 made of the steel plate. However, since the fixing portion 71 inputs the jack-up load to the side sill 20, the required rigidity for the jack-up point can be secured by both the side sill 20 and the frame 5.

This structure does not adversely affect the seal 44 between the frame 5 and the cover 42 and the seal 44 between the frame 5 and the base 43. The battery casing 4 can stably maintain a sealing structure of the accommodation space 40.

Since the extended portion 52 continuously extends from the front end portion to the rear end portion of the side sill 20 in the vehicle front-rear direction, as indicated by two-dot chain lines in FIG. 2, a hanger 10 that supports the vehicle 1 during manufacturing of the vehicle 1 supports the vehicle 1 via the extended portion 52 of the frame 5. A load that is input from the hanger 10 to the vehicle 1 is distributed rather than being input locally. The support of the frame 5 by the hanger 10 does not adversely affect the seal 44 between the frame 5 and the cover 42 and the seal 44 between the frame 5 and the base 43. The frame 5 is not provided with a notch with which the hanger 10 can directly support the side sill 20.

The frame 5 is not limited to being made of the extruded material.

In the lower structure of the vehicle 1 described above, the fastening portion 6 is located at a position that overlaps a cross-sectional center C of the side sill 20 in the vehicle width direction. The cross-sectional center C described herein may be a geometric center of a cross section of the side sill 20 that has a substantially quadrangular shape.

Since the fastening portion 6 is located at the position that overlaps the cross-sectional center C of the side sill 20, a part of the frame 5 of the battery casing 4, that is, a part of the extended portion 52 is at least located on the outer side of the fastening portion 6 in the vehicle width direction. In the vehicle width direction, the outer end of the extended portion 52 in the vehicle width direction is located at a position near the outer wall 202 of the side sill 20. In the example illustrated in FIG. 2, the outer end of the extended portion 52 in the vehicle width direction is located at the same position as the outer wall 202 of the side sill 20.

The outer end of the extended portion 52 in the vehicle width direction is located at the same position as the outer wall 202 of the side sill 20. Thus, as described above, when the initial collision load is input to the side sill 20 during the side collision, the initial collision load is also input to the frame 5 at the same timing or at substantially the same timing.

After the initial collision load is input, the side sill 20 and the frame 5 absorb the energy in parallel.

Since the fastening portion 6 is located at the position that overlaps the cross-sectional center C of the side sill 20 in the vehicle width direction, the lower structure of the vehicle 1 can reduce the energy absorption stroke with respect to the load input during the side collision.

Since the energy absorption stroke by the side sill 20 and the frame 5 is short, the accommodation space 40 of the battery 41 can be expanded in the vehicle width direction. Due to the expansion of the accommodation space 40, it is possible to increase the mounting capacity of the battery 41 in the vehicle 1.

Therefore, the lower structure of the vehicle 1 can increase the mounting capacity of the battery 41 while ensuring the energy absorptive function during the side collision.

The second flange 212 and the fourth flange 224 of the side sill 20 are located between the fastening portion 6 and the body portion 51 in a manner to avoid interference between the fastening portion 6 and the body portion 51 of the frame 5.

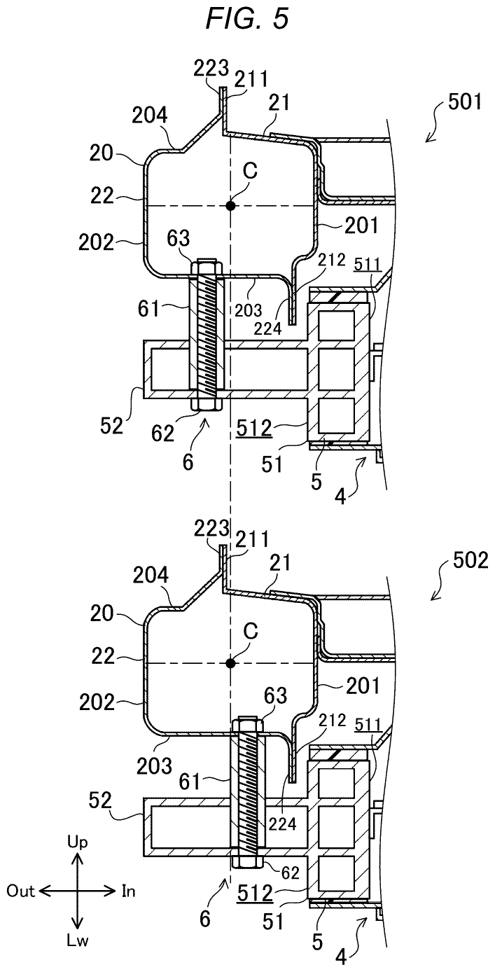

Here, FIG. 5 illustrates a modified example related to the position of the fastening portion 6. As illustrated in an upper view 501 of FIG. 5, the fastening portion 6 may be located on the outer side of the cross-sectional center C of the side sill 20 in the vehicle width direction. In addition, as illustrated in a lower view 502 of FIG. 5, the collar 61 of the fastening portion 6 may be located at the position that overlaps the cross-sectional center C of the side sill 20.

The examples in which the fastening portion 6 is located at the position overlapping the cross-sectional center C of the side sill 20 or is located on the outer side of the cross-sectional center C in the vehicle width direction may include various examples in addition to the example in FIG. 2 or FIG. 5.

As illustrated in FIG. 2, an inner end of the side sill 20 in the vehicle width direction, that is, the inner wall 201 is located on the outer side in the vehicle width direction of an inner end of the frame 5 in the vehicle width direction. The side sill 20 that has a narrow width in the vehicle width direction improves getting-on/off performance of the vehicle 1.

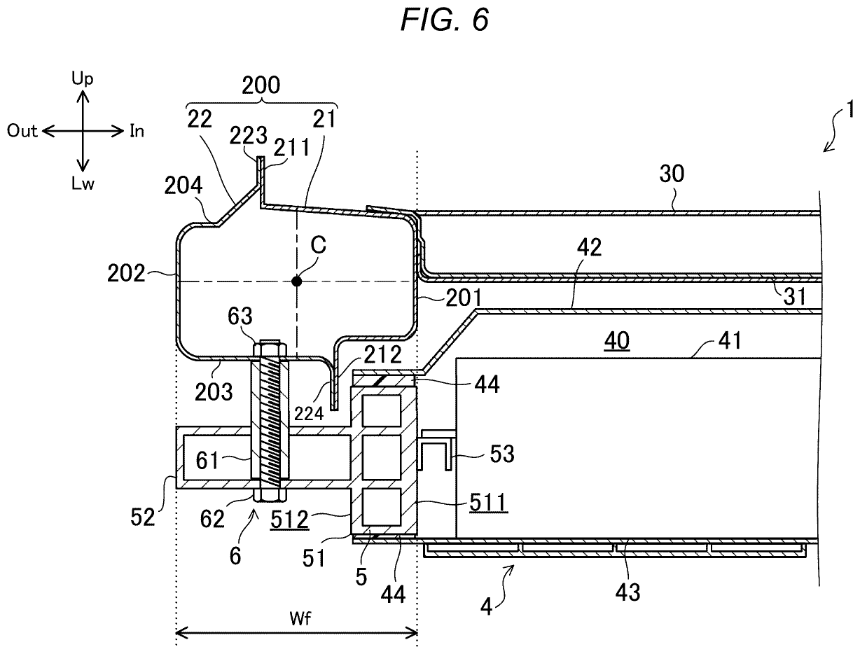

FIG. 6 illustrates a modified example of the shape of the side sill. The inner wall 201 of a side sill 200 is located at the same position as the inner end of the frame 5 in the vehicle width direction. The entire side sill 20 overlaps the frame 5 in the vehicle width direction. The body portion 51 of the frame 5 is located under the inner 21 of the side sill 20.

In other words, the frame 5 is not located on the inner side of the side sill 200 in the vehicle width direction. Since the frame 5 is located on the outer side in the vehicle width direction, the accommodation space 40 of the battery 41 can be expanded in the vehicle width direction.

What is claimed is:

1. A vehicle lower structure comprising:
a side sill that has a closed cross-section located in a side end portion of a floor panel in a vehicle width direction and extending in a vehicle front-rear direction;
a battery casing that is located under the floor panel and has a battery accommodated in an accommodation space; and
a fastening portion that fastens the battery casing to a lower portion of the side sill, wherein
the fastening portion is located at a position that overlaps a cross-sectional center of the side sill in the vehicle width direction, or is located on an outer side of the cross-sectional center in the vehicle width direction.

2. The vehicle lower structure according to claim 1, wherein
the battery casing has a frame that is located in an outer edge portion of the battery casing in the vehicle width direction, extends in the vehicle front-rear direction, and forms the accommodation space on an inner side in the vehicle width direction, and
the fastening portion fastens the frame to the lower portion of the side sill.

3. The vehicle lower structure according to claim 2, wherein
an inner end of the side sill in the vehicle width direction is located at the same position as an inner end of the frame in the vehicle width direction, or is located on an outer side of the inner end of the frame in the vehicle width direction.

4. The vehicle lower structure according to claim 2, wherein
in the vehicle width direction, an outer end of the frame in the vehicle width direction is located at substantially the same position as an outer end of the side sill in the vehicle width direction.

5. The vehicle lower structure according to claim 2 further comprising:
a jack-up attachment that is attached to a lower surface of the frame.

6. The vehicle lower structure according to claim 5, wherein
the jack-up attachment has a fixing portion that penetrates the frame in an up-down direction and is fixed to a lower portion of the side sill.

7. The vehicle lower structure according to claim 5, wherein
the frame is an extruded material of an aluminum alloy.

8. The vehicle lower structure according to claim 6, wherein
the frame is an extruded material of an aluminum alloy.

9. The vehicle lower structure according to claim 2, wherein
the side sill has an inner and an outer that are joined to each other in the vehicle width direction, and
the fastening portion is fastened to the outer.

10. The vehicle lower structure according to claim 2, wherein
the fastening portion includes a collar that is interposed between a lower portion of the side sill and the frame; and a bolt that is inserted in the collar and fastens the frame and the side sill.
